(19) United States
(12) Patent Application Publication
(10) Pub. No.: US 2015/0064656 A1
(43) Pub. Date: Mar. 5, 2015

(54) SHARING FLIGHT RESOURCES

(71) Applicant: Flying Software Labs, LLC, Draper, UT (US)

(72) Inventor: Jack M. Garzella, Draper, UT (US)

(21) Appl. No.: 14/019,321

(22) Filed: Sep. 5, 2013

(51) Int. Cl. G09B 19/16

(52) U.S. Cl. CPC G09B 19/165
USPC 434/30

(57) ABSTRACT

Systems and methods are described for sharing flight resources between a plurality of flight entities. A method may include identifying a flight resource that is to be shared between flight entities where the flight resource has a profile having a definition of the flight resource and attributes that identifies the flight resource. A shared schedule that is associated with the flight resource can be generated and the shared schedule can be provided to the flight entities that have been identified as being authorized to schedule and use the flight resource. An authorized flight entity can schedule the flight resource by providing a request to schedule the flight resource during a block of time.

### BACKGROUND

Those wishing to become aircraft pilots in most cases attend a flight training school where a course of study is used to teach a student to pilot an aircraft. Through flight training, a student may be taught primary and intermediate airmanship skills that provide the student with an acquaintance of the principles of flight. As a result, a student may leave flight school having an ability to operate an aircraft with competence and precision on the ground and in the air, as well as the ability to exercise good judgment in the operation, safety and efficiency of an aircraft.

Flight resources utilized by flight businesses to train pilots can be expensive, both to purchase and to maintain. A single aircraft can cost tens of thousands of dollars or more and may require additional staff and equipment to maintain the aircraft. In addition, aircraft, flight instructors and pilot training activities may be regulated by governments. Due to these flight training related regulations, flight businesses may be burdened with additional procedures, rules and paperwork that add complexity and cost to managing a flight business. The complexity and costs of complying with the procedures, rules, and paperwork can make it difficult to operate a flight business.

### BRIEF DESCRIPTION OF THE DRAWINGS

FIG. 1 is a diagram illustrating an example system for sharing a flight resource between a plurality of flight entities.

FIG. 2 is a block diagram illustrating the components of an example system for sharing flight resources between a number of flight entities.

FIG. 3 is a flow diagram that illustrates an example method for sharing flight resources between a plurality of entities.

FIG. 4 is a diagram illustrating an example graphical user interface that is used to view and edit a flight resource profile.

FIG. 5 is a diagram illustrating an example schedule for a flight resource.

FIG. 6 is a diagram that illustrates an example graphical user interface used for booking a flight resource.

FIG. 7 is a flow diagram illustrating an example method for scheduling a shared flight resource between a number of flight entities.

FIG. 8 is a flow diagram that illustrates an example method for sharing a flight resource profile between a number of flight entities.

FIG. 9 is a block diagram illustrating an example computing device used for sharing and scheduling a flight resource between a plurality of flight entities.

### DETAILED DESCRIPTION

Although the following detailed description contains many specifics for the purpose of illustration, a person of ordinary skill in the art will appreciate that many variations and alterations to the following details can be made and are considered to be included herein.

Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical terms used herein have the same meaning as commonly understood by one of ordinary skill in the art to which this disclosure belongs.

A technology is described for sharing a flight resource between a number of flight entities via a flight management system that enables a flight entity to schedule the shared flight resource. A flight management system can support entities that operate flight businesses and/or clubs. For instance, a flight entity may include, but is not limited to, flight schools that teach students to operate various aircraft, flight businesses that rent and/or charter aircraft to the public and flight clubs comprised of member pilots. A flight management system may be used to manage a flight entity's operations. For instance, a flight management system can be used to schedule flight resources, flight lessons, validate that flight training rules are being followed, track aircraft used by a flight entity, ensure compliance to governmental regulations and proprietary rules, and integrate billing features as well as other functions related to a flight entity.

A flight resource may be any resource that a flight entity may have rights to. For example, a flight resource may include, but is not limited to, an aircraft, flight related equipment such as a flight simulator, a building, a room (e.g., classroom), personnel, a pilot, instructor, syllabi, courses, lessons, training materials, etc. In some cases, two or more flight entities may share a flight resource asset between the flight entities. For example, two flight entities may share an aircraft, an aircraft hangar, a flight simulator, flight lesson facilities, etc. Various sharing arrangements may exist between flight entities. In one example, flight entities sharing the flight resource may each own a share of the flight resource. In another example, a flight entity owning a flight resource may share the flight resource with a second flight entity by renting or leasing the flight resource to the second flight entity. Regardless of the sharing arrangement, in order to avoid scheduling conflicts, flight entities can benefit from a flight management system that enables scheduling of a shared flight resource between the flight entities.

Currently, flight entities that use existing systems to manage the flight entity's flight resources may not have the ability to schedule a flight resource between two or more flight entities. In other words, a flight entity may not have the ability to share and schedule a flight resource with another flight entity using a management system. In a case where a flight entity wishes to share a flight resource with another entity, arrangements to share the flight resource may have to be made outside of the entities' respective management systems.

The sharing of flight resources can be more complex than merely calendaring the time during which each entity uses the flight resource. Sharing can involve the sharing of fuel costs, maintenance costs, aircraft depreciation costs, and so forth. The records associated with these costs may need to be identified and maintained separately by each entity. The ability to use information that is already available in a flight management system can significantly reduce the time, effort, and resources needed to share flight resources. In addition, the technology can enable the sharing of lower cost flight resources. The sharing of lower cost flight resources may not have been profitable prior to this technology, due to the time and resources required to separately track the information needed to effectively share the flight resources. By simplifying the process of sharing a flight resource, the technology described herein enables flight entities to make better use of their capital equipment, thereby reducing costs and/or increasing profits.

The present technology can allow two or more flight entities using a flight management system to create a shared flight resource profile for a shared flight resource and enables the flight entities to schedule (reserve) the flight resource. In one example configuration, a profile for a flight resource that is shared between two or more entities can be identified. The profile can contain information about the shared flight resource such that the shared resource can be identified. Having identified the flight resource, a schedule can then be generated for the flight resource and the schedule can be provided to the flight entities that are sharing the flight resource. When a request to schedule the flight resource for a block of time is received from a flight entity, a determination can be made whether the flight resource is available during the block of time. If the flight resource is available during the block of time, then an indication may be made on the schedule that the flight resource is unavailable during the block of time to other flight entities that share the flight resource.

In another example configuration, a flight resource may be identified from an associated profile and a schedule may be generated for the flight resource. The schedule may be provided to flight entities that have been authorized to make requests to reserve and use the flight resource. When a flight entity makes a request to reserve the flight resource, a determination can be made whether the flight resource is available during the time that the flight entity is requesting. The determination can be made by referencing the shared schedule that is associated with the flight resource. After referencing the shared schedule and determining that the flight resource is available, an acceptance can be provided to the requesting flight entity and the flight resource can be scheduled for the time requested.

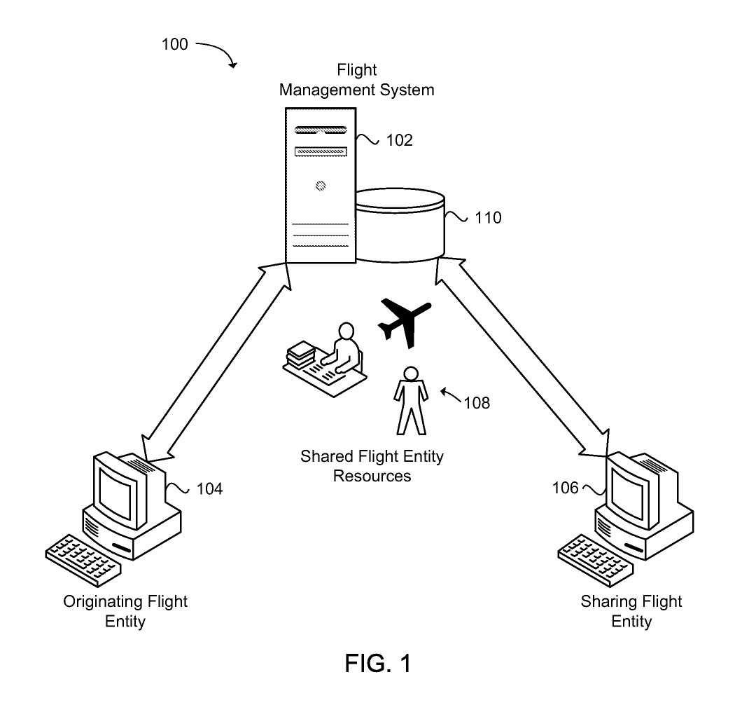

FIG. 1 is a diagram illustrating a system 100 for sharing a flight resource 108 between a plurality of entities. The system 100 can include a client device 104 that may be in communication with a flight management system that is executed on an application server 102. The application server 102 may include a data store 110, upon which a shared resource schedule may be stored. A user may request to schedule a flight resource 108 using the client device 104. The request may be transmitted to the application server 102 over a communications network where, upon receiving the request, the application server 102 may authenticate the user. A user may be authenticated using a role and a profile that may be associated with the user. For example, a flight management system executing on the application server 102 may be accessed by a number of flight entity users, each of which may be assigned one or more roles and one or more profiles.

A role may determine which system rights a flight entity user may have within the flight management system (e.g., read-only, read-write, administrator, etc.) and may determine which information the user may view (e.g., flight resource information, aircraft maintenance information, pilot profile, resource scheduling information, etc.). A flight management system may contain various roles, including an administrator role, pilot role, instructor role, maintenance role, staff role, as well as other types of roles that can be created within the flight management system. A role may enable a user to perform certain actions within the flight management system. As an example, a user wishing to schedule a shared flight resource 108 may need to be assigned a role that provides the user with scheduling rights for the flight resource 108 within the flight management system.

Once a user has been authenticated to schedule a shared flight resource 108 based on the user's role and profile, a flight resource 108 that may be associated with the user can be identified and a determination may be made whether the flight resource 108 is available during the block of time that the user is requesting to schedule the flight resource 108. A flight resource 108 is any resource that a flight entity may have rights to, such as, but not limited to, an aircraft, simulator, equipment, building (e.g., flight hanger), airstrip, classroom, personnel, training materials, etc. In a case where the flight resource 108 is available during the requested block of time, the flight resource 108 may be scheduled by indicating on an electronic schedule that can be made accessible to flight entities sharing the flight resource 108 that the flight resource 108 has been scheduled for the block of time.

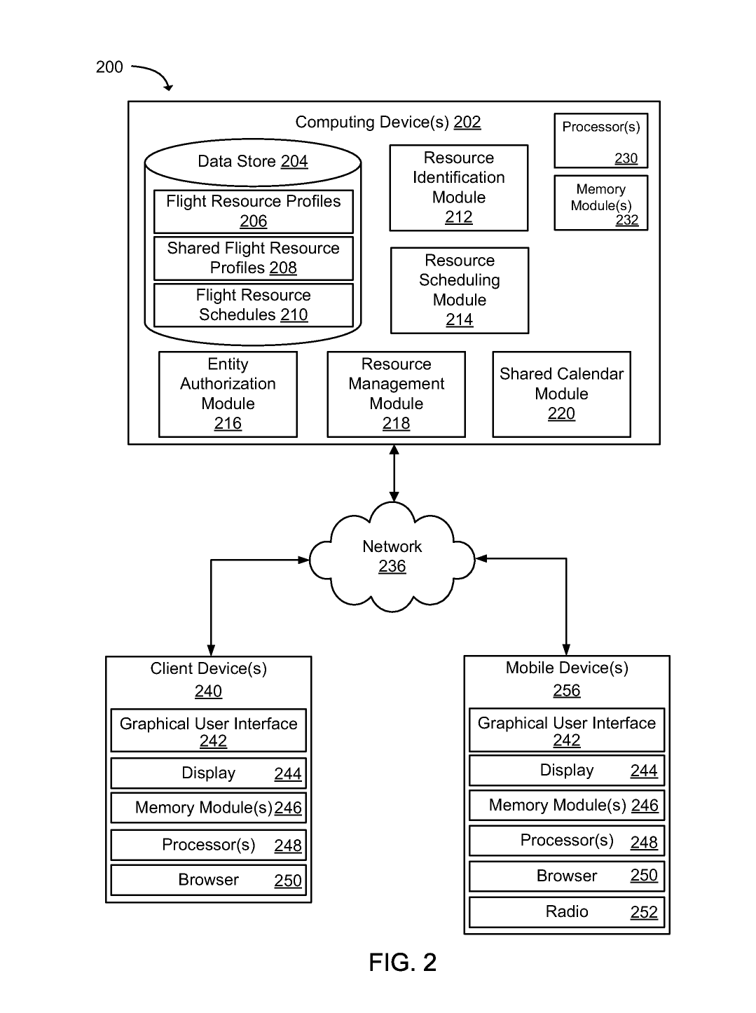

FIG. 2 illustrates an example of various components of a flight management system 200 used for sharing a flight resource and scheduling the flight resource. The flight management system 200 may contain one or more computing devices 202 that may be in communication with a number of client devices 240 and/or mobile devices 256 by way of a communications network 236.

In one example configuration, the computing device 202 may include a data store 204 that contains various data, including flight resource profiles 206, shared flight resource profiles 208 and flight resource schedules 210. A flight resource profile 206 can include information about a flight resource. For instance, a flight resource profile 206 may contain attributes about a flight resource, such as in the case of an aircraft, attributes may include an aircraft type, make, model, manufacture, manufacture date, etc. Whereas in the case where a flight resource is a building, attributes may include an address, lot size, building square feet, room numbers, etc. A shared flight resource profile 208 may be a profile with attributes for a flight resource that is shared between two or more flight entities. An example shared flight resource profile 208 may include attributes like flight resource type, location, sharing flight entities, flight resource details, etc. A shared flight resource profile 208 can be constructed using attributes from an originating flight resource profile 206 and adding additional attributes related to a sharing arrangement between flight entities.

In one example configuration, a shared flight resource profile 208 can be constructed by an originating flight entity (i.e., the flight entity that owns the flight resource). The flight entity can first, select a flight resource that will be shared between the flight entity and two or more other flight entities, identify the flight entities that will share the flight resource and select attributes from a flight resource profile 206 that will be shared with the flight entities. A shared flight resource profile 208 can then be built that specifies which flight entities share an associated flight resource.

As an illustration, an originating flight entity having a flight resource that will be shared with a second flight entity may create a shared flight resource profile 208 within a flight management system 200. When creating the shared flight resource profile 208, the originating flight entity can select a flight resource that will be shared with the second flight entity. When selecting the flight resource, a flight resource profile 206 that is associated with the flight resource may be identified and information from the flight resource profile 206 can be used to build a shared flight resource profile 208. The originating flight entity can select attributes from the flight resource profile 206 that will be made part of the shared flight resource profile 208.

In one example, some attributes of the shared flight resource profile 208 may be static and therefore “read-only”, e.g., flight resource attributes that cannot be changed, such as aircraft make, model and manufacturer. In another example, some attributes may be “owned” by an originating flight entity, and therefore can be modified by the originating flight entity, but may be “read-only” for a second flight entity. And in another example, a second flight entity can add the second flight entity's own attributes to a shared flight resource profile 208 that may be useful to the second flight entity. For example, the second flight entity may have different numbering schemes used to track the flight resource. In some cases, these added attributes may be visible only to the flight entity that added the additional attributes. In other cases, added attributes may be visible to any flight entity that has access to the shared flight resource profile 208. In addition, there may be selected flight resource attributes that may only be visible to the originating flight entity such as payroll data, human resource data, proprietary or private profile data, billing data, etc.

In another example configuration, two or more flight entities that collectively own a flight resource can create a shared flight resource profile 208 for the flight resource. The two or more flight entities can determine which attributes from a flight resource profile 206 that will be used to construct the shared flight resource profile 208. Pre-defined attributes of a flight resource (e.g., flight resource type, manufacturer, pilot profiles, maintenance attributes, etc.) can be used and additional attributes that may be defined by a flight entity (i.e., custom attributes) can be added to the shared flight resource profile 208.

A shared flight resource profile 208 can be stored in a data store 204 on a computing device 202 that is accessible to flight entities sharing a resource. For example, the computing device 202 may be a server that may be accessible over a communications network 236 by all flight entities that share a flight resource.

In another example configuration, each flight entity sharing a flight resource can maintain a local copy of the shared flight resource profile 208 on a computing device 202 owned and maintained by a flight entity. Attributes of the shared flight resource profile 208 that may be shared among the flight entities may be linked to a master shared flight resource profile 208, and therefore may be “read-only”. For example, two flight entities may share a classroom that is used for ground lessons. An attribute of a shared flight resource profile 208 for the classroom may be a room number (e.g., room 103). An originating flight entity may provide the room number attribute and include the attribute in a shared flight resource profile 208 that is stored on the originating flight entity's computing device 202. A second flight entity may maintain a copy of the shared flight resource profile on the second flight entity's own computing device 202. The room number attribute of the second flight entity's copy of the shared flight resource profile can be linked via an API (application programming interface) to the room number attribute of the originating flight entity's shared flight resource profile.

As another example of sharing a flight resource between entities, an instructor may be a flight resource that can be shared between two or more flight entities. A first flight entity may maintain a local copy of a shared flight resource profile 208 for the instructor and a second flight entity may maintain their own local copy of a shared flight resource profile 208 for the instructor. As noted above, some attributes of the shared flight resource profile 208 may be read-only, such as the instructors name and other personal attributes, whereas other attributes may be specific to a flight entity. As an example, under the United States Code of Federal Regulations, i.e., 14 CFR Part 141, pilot schools are required by the FAA to certify an instructor teaching at a pilot school. Therefore, each pilot school separately certifies the pilot's school's instructors. In a case where an instructor is shared between two pilot schools, each pilot school must certify the instructor and add that certification to the shared flight resource profile 208. Thus, a first pilot school may add the first pilot school's instructor certification to the shared flight resource profile 208, where the certification may only be visible on the first pilot school's local copy of the shared flight resource profile 208. Moreover, a second pilot school may add the second pilot school's instructor certification to their copy of the shared flight resource profile 208 and likewise, the added certification may be visible only to the second pilot school.

The computing device 202 may include modules containing instructions that when executed by a processor 230 perform certain actions. These modules may include an entity authorization module 216, a resource identification module 212, a resource scheduling module 214, a resource management module 218, a shared calendar module 220 as well as other services, processes, systems, engines, or functionality not discussed in detail herein.

The entity authorization module 216 can be configured to determine which flight entities have been authorized to view and schedule a shared flight resource. In one example, authorization to view and schedule a shared flight resource can be determined by referencing a shared flight resource profile 208 associated with a specific flight resource. Included in the attributes may be an attribute that defines flight entities that can view and schedule the flight resource. In an alternative example configuration, a profile associated with a flight entity can include information about flight resources that the flight entity owns and shares with other flight entities and/or information about flight resources that are shared with the flight entity.

Once a flight entity has been determined to have authorization to view and schedule a shared flight resource, the flight resource and functions associated with the flight resource can be made available to the flight entity in the flight management system.

The resource identification module 212 can identify flight resources that are shared between flight entities. For example, when a flight entity user accesses the flight management system 200, flight resources that are shared with the flight entity can be identified using the resource identification module 212. In one example configuration, a shared flight resource may be identified by querying the data store 204 for shared flight resource profiles 208. Attributes included in a shared flight resource profile 208 can include attributes that identify flight entities that share the flight resource associated with the shared flight resource profile 208. When a flight resource is identified as being shared with a flight entity, a shared flight resource profile 208 associated with the flight resource can then be provided to a flight entity user of the flight management system 200 as well as other modules within the flight management system 200.

The resource scheduling module 214 can be configured to receive a request to schedule a shared flight resource during a block of time (e.g., 8:00 am to 10:00 am) from a flight entity and determine whether the flight entity may be authorized to schedule the flight resource. In one example configuration, the resource scheduling module 214 can call other modules within the flight management system via an API (application programming interface) to determine whether a flight entity may be authorized to schedule a flight resource. For example, the entity authorization module 216 can be called to validate a flight entity. After validating the flight entity, a flight resource schedule 210 that is associated with the flight resource can be queried to determine whether the flight resource is available during the block of time requested. After determining whether the flight resource is available during the block of time requested, the block of time can be scheduled in the flight resource schedule 210.

The shared calendar module 220 can be configured to provide a shared schedule for a shared flight resource to those flight entities that are sharing the flight resource. In addition, the shared calendar module 220 can include functionality that enables a flight management system user to manage a flight resource schedule (e.g., edit a schedule). In one example configuration, a graphical user interface can be provided to a user that displays a schedule for a shared flight resource. Blocks of time may be graphically shown where a block of time can be displayed in a manner indicating that the shared flight resource has been scheduled during the block of time. For example, the block of time can be displayed using a color that signifies that the flight resource has been scheduled and/or text can be displayed within the block of time that informs a user that the flight resource has been scheduled.

As indicated above, in addition to providing and displaying a shared schedule, the shared calendar module 220 can include functionality that enables a user to manage a shared schedule. Functionality may include, but is not limited to, editing, deleting and copying a flight resource reservation. For example, a user may edit a reservation or modify certain attributes of a reservation, such as change a start time, end time or date of a flight resource reservation or modify a reservation description, location, etc.

The resource management module 218 can be configured to enable an originating flight entity (i.e., the entity that owns the flight resource) to manage a flight resource that the originating flight entity may be sharing with another flight entity. For example, attributes of a shared flight resource profile 208 can be managed by an originating flight entity. The originating entity can create and/or edit definitions and attributes of the shared flight resource profile 208. In another example configuration, the resource management module 218 can be used by all flight entities that share a flight resource to manage attributes of the shared flight resource profile 208 that are not read-only (i.e., not static). For example, a flight entity can update operating and/or maintenance attributes of the shared flight resource profile 208 when one of the flight entities sharing the flight resource uses the flight resource.

The client device 240 and the mobile device 256 included in the flight management system 200 may include any device that may be capable of sending and receiving data over a communications network 236. The communications network 236 may be a wired or a wireless network such as the Internet, a local area network (LAN), wide area network (WAN), wireless local area network (WLAN), or wireless wide area network (WWAN). The WLAN may be implemented using a wireless standard such as Bluetooth or the Institute of Electronics and Electrical Engineers (IEEE) 802.11-2012, 802.11ac, 802.11ad standards, or other WLAN standards. The WWAN may be implemented using a wireless standard such as the IEEE 802.16-2009 or the third generation partnership project (3GPP) long term evolution (LTE) releases 8, 9, 10 or 11 or other WWAN standards. Components utilized for such a system may depend at least in part upon the type of network and/or environment selected. Communication over the network 236 may be enabled by wired or wireless connections and combinations thereof.

A client device 240 and a mobile device 256 may comprise, for example, a processor-based system such as a computing device. Such a computing device may contain one or more processors 248, one or more memory modules 246 and a graphical user interface 242. A client device 240 may be a device such as, but not limited to, a desktop computer, mainframe computer system, workstation as well as other devices with like capability. A mobile device 256 may be a device such as laptop or notebook computer, tablet computer, handheld computer, smartphone or other devices with like capability. The client device 240 and the mobile device 256 may have one or more applications installed that may provide access to a flight management system 200. Also, a client device 240 and a mobile device 256 may include a browser 250 that may enable the communication with the computing device 202 by way of a server side executed application that may be displayed within the browser 250. The mobile device 256 may contain a radio 252 that enables the mobile device 256 to connect to a communications network 236 by way of a WWAN or WLAN, as previously discussed. The client device 240 and the mobile device 256 may include a display 244, such as a liquid crystal display (LCD) screen, gas plasma-based flat panel display, LCD projector, cathode ray tube (CRT), or other types of display devices, etc.

The various processes and/or other functionality contained on the computing device 210 may be executed on one or more processors 230 that are in communication with one or more memory modules 232 according to various examples. The computing device 210 may comprise, for example, of a server or any other system providing computing capability. Alternatively, a number of computing devices 210 may be employed that are arranged, for example, in one or more server banks or computer banks or other arrangements. For purposes of convenience, the computing device 210 is referred to in the singular. However, it is understood that a plurality of computing devices 210 may be employed in the various arrangements as described above.

Various data may be stored in the data store 204 that is accessible to the computing device 202. The term “data store” may refer to any device or combination of devices capable of storing, accessing, organizing and/or retrieving data, which may include any combination and number of data servers, relational databases, object oriented databases, cloud storage systems, data storage devices, data warehouses, flat files and data storage configuration in any centralized, distributed, or clustered environment. The storage system components of the data store 204 may include storage systems such as a SAN (Storage Area Network), cloud storage network, volatile or non-volatile RAM, optical media, or hard-drive type media. The data store 204 may be representative of a plurality of data stores 204 as can be appreciated.

FIG. 2 illustrates that certain processing modules may be discussed in connection with the present technology and these processing modules may be implemented as computing services. In one example configuration, a module may be considered a service with one or more processes executing on a server or other computer hardware. Such services may be centrally hosted functionality or a service application that may receive requests and provide output to other services or consumer devices. For example, modules providing services may be considered on-demand computing that are hosted in a server, cloud, grid or cluster computing system. An API (application program interface) may be provided for each module to enable a second module to send requests to and receive output from the first module. Such APIs may also allow third parties to interface with the module and make requests and receive output from the modules. While FIG. 2 illustrates an example of a flight management system 200 that may implement the techniques above, many other similar or different environments are possible. The example environments discussed and illustrated above are merely representative and not limiting.

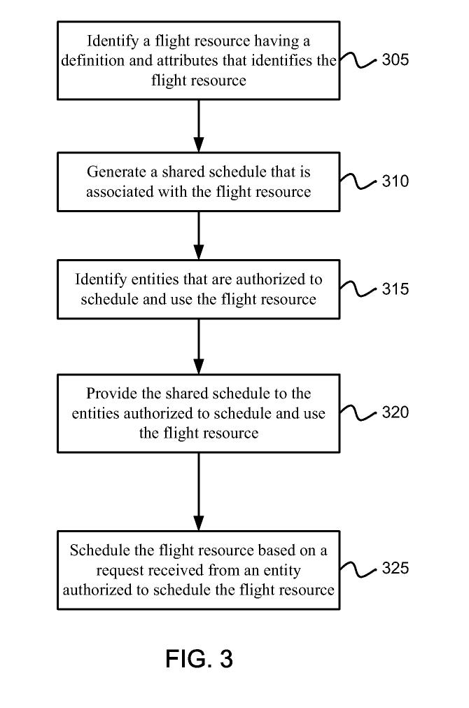

FIG. 3 is a flow diagram illustrating an example method for sharing a flight resource between a plurality of flight entities. Beginning in block 305, a flight resource that is to be shared between two or more flight entities can be identified, the flight resource can have a definition and attributes that identifies the flight resource. In one example configuration, a flight resource can be identified using a flight resource profile that is associated with the flight resource. The flight resource profile can include a description of the flight resource and can contain attributes that define the flight resource.

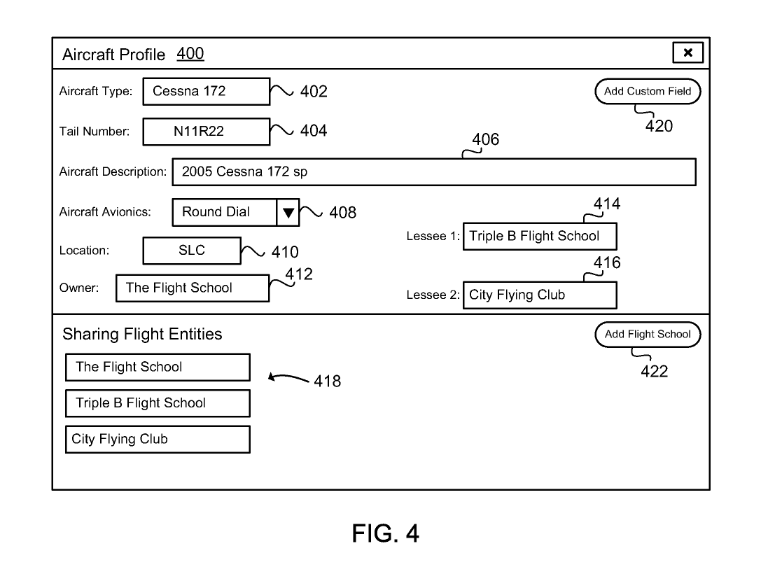

As an illustration, referring to FIG. 4, an example of a graphical user interface is shown that displays a flight resource profile for an aircraft. The aircraft profile 400 can contain attributes that describe the aircraft, such as an aircraft type 402, an aircraft tail number 404 and an aircraft description 406. Some attributes of a flight resource profile may be key attributes that may be static (read-only). For instance, the attribute aircraft type 402 may be a key attribute that is static. Whereas other attributes may not be static and can be modified by a flight entity. For example, the location 410 of an aircraft can change, and therefore, the aircraft profile 400 can be updated to reflect the change. In some cases, attributes of flight resource profile can be updated when a flight resource is upgraded or modified. As an example, an aircraft profile 400 may contain an attribute that specifies what type of aircraft avionics 408 that the aircraft is equipped with. In a case where the aircraft avionics may be upgraded from round dial avionics to digital avionics, the aircraft avionics 408 attribute of the aircraft profile 400 can be updated to reflect the upgrade.

Some attributes of a flight resource profile may be pre-defined attributes, such as the key attributes described above, and other attributes may be defined by an originating flight entity or a sharing flight entity. In one example configuration, an originating flight entity may determine which attributes associated with a shared flight resource will be shared with another flight entity. For example, the originating entity may decide to share all key attributes of a flight resource profile, but may not share custom attributes that the originating entity may have created. In addition to sharing the flight profile attributes, an originating entity can determine which system access permissions are granted for the attributes. For example, the originating entity can grant read-only permissions to key attributes so that a sharing entity cannot modify the attribute. For other attributes, the originating entity may grant read-write permissions that enable a sharing flight entity to modify an attribute, such as the location 410 attribute.

In an example configuration, flight entities sharing a flight resource can provide attributes associated with the flight resource that a flight entity has created with other flight entities. For example, a flight entity can create a custom attribute by adding a custom field 420 to an aircraft profile 400 and the custom attribute can be made visible within a flight management system to other flight entities sharing the flight resource. As a specific example, an owner flight school 412 of an aircraft can add a custom attribute 420 to an aircraft profile 400 for a number of lessee flight schools who may be sharing the aircraft with the owner flight school. The owner flight school 412 may create a first lessee attribute 414 and make the first lessee attribute 414 visible to a first lessee. The owner flight school 412 may create a second lessee attribute 416 and make the second lessee attribute 416 visible to a second lessee, but not to the first lessee, thereby preventing the first lessee from seeing that the aircraft is shared with the second lessee.

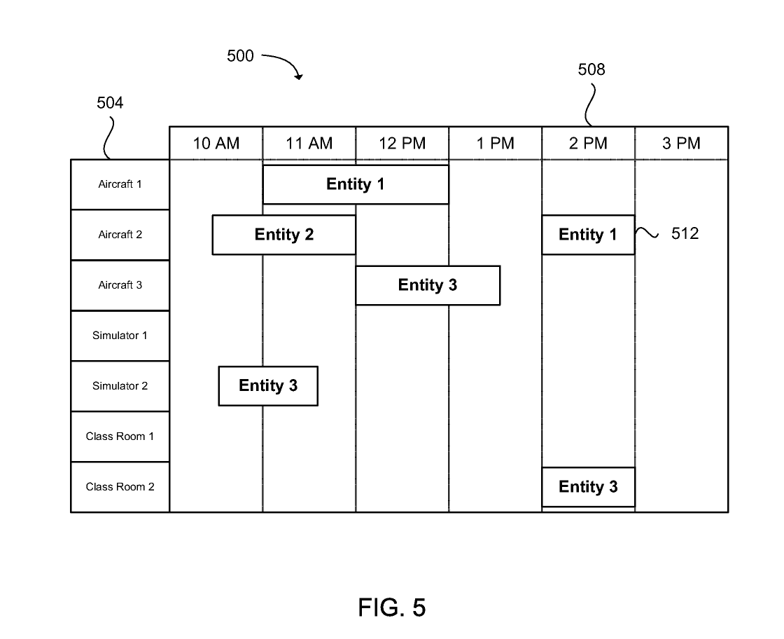

Returning to FIG. 3, after a flight resource has been identified using a flight resource profile, as in block 310, a shared schedule can be generated that is associated with the flight resource. In one example configuration, the shared schedule can be an electronic schedule that can be displayed within a flight management system on a client device. Referring to FIG. 5, shown is an example electronic schedule 500 for a number of shared flight resources. The schedule 500 may contain a column 504 with rows that contain the flight resources. The schedule 500 may be divided into multiple blocks of time (e.g., one hour blocks) wherein a flight resource can be scheduled. A block of time 508 displayed on the schedule 500 can be scheduled for a flight resource and a visual indicator 512 can be displayed within the block of time 508 so as to indicate that the flight resource has been scheduled for the block of time 508 by a flight entity. Of course the example schedule 500 of FIG. 5 is merely one example of an electronic schedule that can be provided to a flight entity, any schedule that can be shared among a number of flight entities is within the scope of the present technology, including non-graphical user interfaces.

Returning to FIG. 3, as in block 315, flight entities that are authorized to schedule and use the flight resource can be identified. In one example configuration, a flight entity that may be authorized to view and schedule a flight resource may be identified using a flight resource profile. The flight resource profile can contain those flight entities that share a resource. For example, referring again to FIG. 4, the aircraft profile 400 can contain fields 418 that show which flight entities (e.g., flight schools, flight clubs, aircraft charter operators, etc.) share the aircraft associated with the aircraft profile 400. Additional flight entities can be added 422 to the list of sharing flight entities and flight entities can be removed from the list by deleting the flight entity from an associated field 418. In one example, when determining whether a flight entity is authorized to schedule and use the aircraft associated with the aircraft profile 400, a process can access the sharing flight entities fields 418 of the aircraft profile 400 and determine whether the flight entity making a request is contained within one of the fields 418. As will be appreciated, the graphical user interface depicted in FIG. 4 is merely one example of a flight resource profile that can be used to identify authorized flight entities and is intended to be representative and not limiting. In another example configuration, a list of authorized flight entities that share flight resources can be stored in a data store or a flat file that can be queried by a flight management system to determine whether a flight entity is authorized to schedule a particular flight resource.

Returning again to FIG. 3, as in block 320, the shared schedule can be provided to the flight entities that were identified above as being authorized to schedule and use the flight resource. Those flight entities that are authorized to view the shared schedule can, in one example, access the shared schedule via a flight management system. The shared schedule can be a displayed in a graphical user interface format as depicted in FIG. 5 showing blocks of time and shared flight resources. For example, several flight schools may share a number of flight resources, such as aircraft, flight simulators and class rooms. Each flight resource may be shown on the shared schedule with associated available blocks of time. A flight entity user can view the shared schedule and see which blocks of time are available for scheduling a flight resource and during which blocks of time a flight resource has been scheduled by another flight entity.

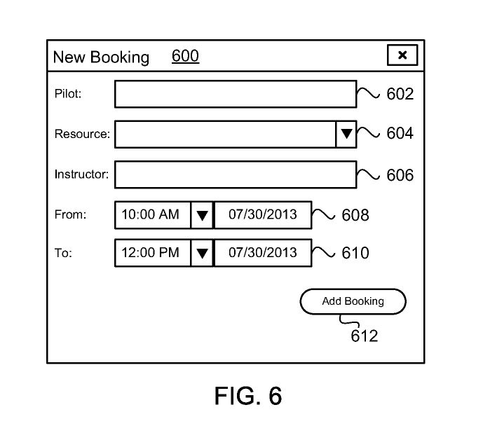

As in block 325, a flight resource can be scheduled based on a request received from a flight entity authorized to schedule the flight resource. In one example configuration, an authorized flight entity user can request to schedule a specific flight resource by submitting a booking request for the flight resource. As an illustration, a flight school that shares flight resources with another second flight school can submit a booking request using a graphical user interface similar to that of FIG. 6. The graphical user interface used for a booking request may include a number of fields that enable a flight entity user to provide information used to book a flight resource. For example, a new booking 600 can include a field for a student pilot 602 that will be operating the flight resource or attending a class, a field for the flight resource 604 that the flight entity user would like to book and a field for an instructor 606 that will be instructing the student pilot. The new booking 600 can also include fields used to specify a block of time that a flight resource will be scheduled. For example, a start time 608 and an end time 610. Upon providing requested information for the new booking 600, the flight entity user can select an add booking control 612, which then submits the booking request to a flight management system.

Upon receiving a new booking request, a process can determine whether the flight resource requested is available during the block of time specified in the new booking request. The shared schedule can be referenced to determine whether the block of time is available. In a case where the shared schedule shows that the block of time is available, the flight resource can be booked for the block of time by indicating on the shared schedule that the flight resource has been booked by the flight entity. An acceptance of the new booking can be provided to a flight entity user by confirming that the requested flight resource has been booked for the block of time for the flight entity. The flight entity user can then view the shared schedule to confirm that a visual indicator, such as a label, is displayed on the shared calendar within the block of time showing that the flight resource is unavailable to other flight entities during the block of time.

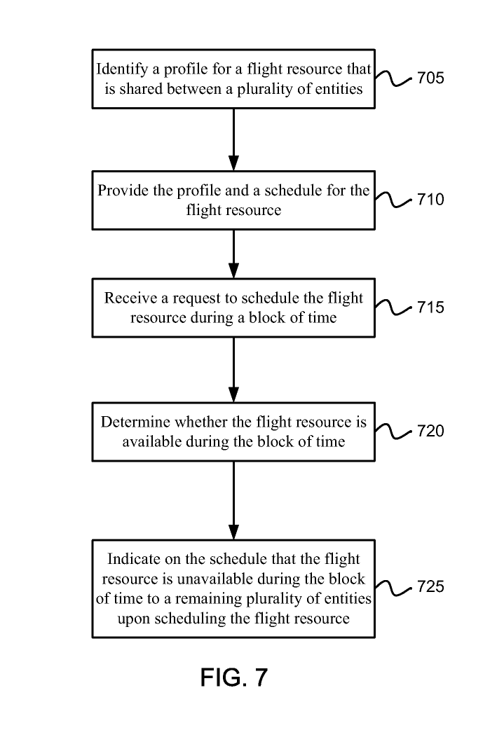

FIG. 7 is a flow diagram illustrating an example method for scheduling a shared flight resource between a number of flight entities. Starting in block 705, a profile for a flight resource that is shared between a plurality of entities can be identified. The profile can contain attributes (information) about the flight resource that enables a user of a flight management system to identify the flight resource as a shared flight resource and view information associated with the flight resource. For example, when accessing a flight management system to reserve a flight resource, a user may be presented with a screen that lists available flight resources. Among the flight resources listed on the screen may be flight resources that are shared with a flight entity affiliated with the user where an indication can be provided that a flight resource is shared between multiple flight entities.

As in block 710, the profile and a schedule for the flight resource can be provided to a flight management system. Continuing the example above, when viewing available flight resources, the user may be provided with access to a profile associated with a shared flight resource and a schedule associated with the shared flight resource. The user can view information about the flight resource that can be provided in the profile and the user can view the schedule to see whether the flight resource may have been reserved by another flight entity during a specific block of time.

As in block 715, a request to schedule the flight resource during a block of time can be received from a flight management system user. After viewing a schedule for a shared flight resource, the user can book the flight resource for a block of time. As an example, a user interface may be used to book the flight resource where the flight resource and a block of time are specified. The user interface can be a graphical user interface as well as a command line user interface that is included in a flight management system.

After submitting a booking request, as in block 720, a determination can be made whether the flight resource is available during the block of time requested. In a case where the flight resource may not be available during the requested block of time, a notification can be provided to a user that the flight resource is not available. In one example, a user can be provided with information that explains why the flight resource is not available at that time (e.g., another flight entity reservation, scheduled for maintenance, unsafe flying conditions, etc.). In a case where the flight resource is available during the requested block of time, the user can be provided with a notification that the reservation of the flight resource was successful and, as in block 725, a schedule associated with the flight resource can be updated to indicate that the flight resource is unavailable during the block of time to a remaining plurality of entities. For example, the block of time shown on the schedule can be blocked-out (i.e., covered or obscured) so as to provide a visual indication to other flight entities that the flight resource has been reserved during the block of time.

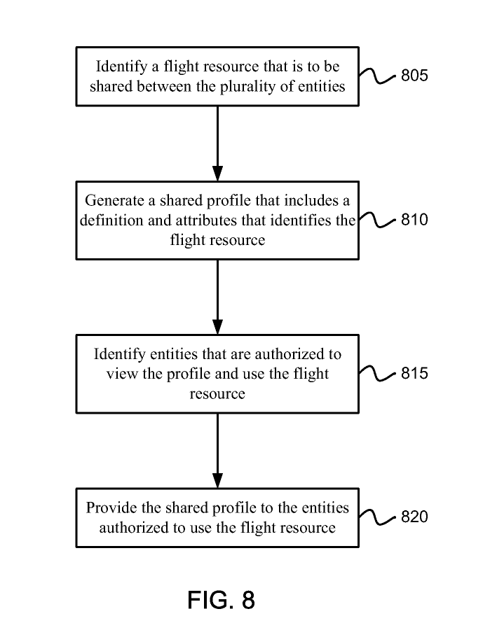

FIG. 8 is a flow diagram illustrating an example method for sharing flight resources between a number of entities. Beginning in block 805, a flight resource that is to be shared between a number of entities can be identified. An entity may be a pilot school, a flight club, an aircraft charter service as well as any other type of entity that may use a flight resource. A flight resource may be any of the flight resources described herein as well as any other resource that may be used within a flight related entity.

As in block 810, after identifying a flight resource, a shared profile that includes a definition and attributes that identifies the flight resource can be generated. The shared profile may be generated using a definition and attributes from an existing profile for the shared resource, where the definition and attributes are copied from the existing profile to the shared profile. Entities sharing the flight resource may, in one example, add additional attributes to the shared profile. Attributes of a shared profile may be configured so that an attribute may be read-only, read-write, visible to sharing entities or hidden from sharing entities as described earlier.

As in block 815, entities that are authorized to view the profile and use the flight resource can be identified. In one example, entities authorized to view the profile and use the flight resource can be identified by an originating entity. The originating entity can designate those entities that will be sharing the flight resource within a flight management system. By designating the sharing entities, a sharing entity database or a sharing entity profile can be generated for the shared flight resource that can be referenced by the flight management system.

As in block 820, the shared profile can be provided to the entities authorized to use the flight resource. For example, entities accessing a flight management system can be provided with a shared profile for a shared flight resource. A sharing entity may view any definitions and attributes included in the shared profile and may, in some cases, add and delete certain definitions and attributes of the shared profile.

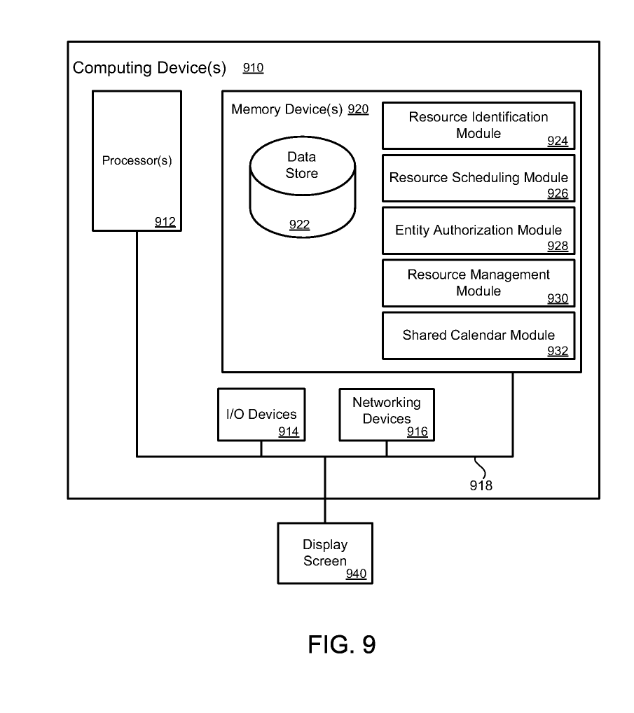

FIG. 9 illustrates a computing device 910 on which modules of this technology may execute. A computing device 910 is illustrated on which a high level example of the technology may be executed. The computing device 910 may include one or more processors 910 that are in communication with memory devices 920. The computing device 910 may include a local communication interface 918 for the components in the computing device. For example, the local communication interface may be a local data bus and/or any related address or control busses as may be desired.

The memory device 920 may contain modules that are executable by the processor(s) 912 and data for the modules. Located in the memory device 920 are services and modules executable by the processor. For example, a resource identification module 924, resource scheduling module 926, entity authorization module 928, resource management module 930, user interface module 932 and other modules may be located in the memory device 920. The modules may execute the functions described earlier. A data store 922 may also be located in the memory device 920 for storing data related to the modules and other applications along with an operating system that is executable by the processor(s) 912.

Other applications may also be stored in the memory device 920 and may be executable by the processor(s) 912. Components or modules discussed in this description that may be implemented in the form of software using high programming level languages that are compiled, interpreted or executed using a hybrid of the methods.

The computing device may also have access to I/O (input/output) devices 914 that are usable by the computing devices. An example of an I/O device is a display screen 940 that is available to display output from the computing devices. Other known I/O device may be used with the computing device as desired. Networking devices 916 and similar communication devices may be included in the computing device. The networking devices 916 may be wired or wireless networking devices that connect to the internet, a LAN, WAN, WLAN, WWAN, or other computing network, as previously discussed.

The components or modules that are shown as being stored in the memory device 920 may be executed by the processor(s) 912. The term “executable” may mean a program file that is in a form that may be executed by a processor 912. For example, a program in a higher level language may be compiled into machine code in a format that may be loaded into a random access portion of the memory device 920 and executed by the processor 912, or source code may be loaded by another executable program and interpreted to generate instructions in a random access portion of the memory to be executed by a processor. The executable program may be stored in any portion or component of the memory device 920. For example, the memory device 920 may be random access memory (RAM), read only memory (ROM), flash memory, a solid state drive, memory card, a hard drive, optical disk, floppy disk, magnetic tape, or any other memory components.

The processor 912 may represent multiple processors and the memory 920 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, non-transitory media such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A computing node operable to schedule a shared flight resource between a plurality entities, having computer circuitry configured to:
identify a profile for a flight resource that is shared between the plurality of entities;
identify a schedule for the flight resource;
provide to the plurality of entities access to the profile and the schedule;
receive a request from one of the plurality of entities to schedule use of the flight resource during a block of time; and
determine whether the flight resource is available during the block of time requested and indicate on the schedule that the flight resource is unavailable during the block of time to a remaining plurality of entities upon scheduling the block of time.

2. The computer circuitry of claim 1, wherein the schedule for the flight resource is an electronic schedule displayed on a client device to a user.

3. The computer circuitry of claim 2, wherein the block of time is displayed on the electronic schedule and provides the user a visual indicator that the block of time has been scheduled by an entity to use the flight resource.

4. The computer circuitry of claim 1, wherein the profile for the flight resource includes a description of the flight resource and a plurality of attributes associated with the flight resource.

5. The computer circuitry of claim 1, wherein the flight resource is a flight school resource.

6. A method for sharing flight resources between a plurality of entities, comprising:
under control of one or more computer systems configured with executable instructions, identifying a flight resource that is to be shared between the plurality of entities;
generating a shared profile that includes a definition and attributes that identifies the flight resource;
identifying entities that are authorized to view the profile and use the flight resource; and
providing the shared profile to the entities authorized to use the flight resource.

7. A method as in claim 6, further comprising scheduling the flight resource based on a request received from an entity authorized to schedule the flight resource.

8. A method as in claim 7, wherein scheduling the flight resource further comprises receiving a request from the entity to schedule the flight resource for a block of time.

9. A method as in claim 7, further comprising determining whether the flight resource is available during the block of time requested by the entity by referencing the shared schedule and providing the entity a schedule request acceptance or a schedule request denial.

10. A method as in claim 6, wherein the definition of the flight resource defines the flight resource as a user, a pilot, an instructor, an aircraft, an aircraft simulator, a flight course, a syllabus, a lesson, a building, a room, training materials or personnel.

11. A method as in claim 6, further comprising identifying flight resource attributes that are static key attributes shared between entities.

12. A method as in claim 6, wherein an attribute of the flight resource is an attribute provided from an entity created profile used to create the flight resource in a flight management system.

13. A method as in claim 6, wherein an attribute of the flight resource is a pre-defined attribute that is assigned to the flight resource when the flight resource is created in a flight management system.

14. A method as in claim 6, wherein an originating entity that shares a flight resource with another entity determines which flight resources belonging to the originating entity will be shared and determines the entity that will share the flight resource with the originating entity.

15. A method as in claim 13, wherein the originating entity determines which system access permissions are granted to an entity for attributes of the flight resource that is being shared with the entity.

16. A method as in claim 13, wherein the originating entity determines which attributes associated with a shared flight resource will be shared with another entity.

17. A method as in claim 13, wherein an entity sharing a flight resource with the originating entity provides attributes associated with the flight resource that is visible to the entity when viewing the flight resource in a flight management system.

18. A non-transitory machine readable storage medium, including program code, when executed to cause a machine to perform the method of claim 6.

19. A system for sharing a flight resource between a plurality of entities, comprising:
at least one computing device having at least one processor;
a shared schedule stored in a data store accessible to the at least on computing device;
a memory device including instructions, that when executed by the processor, cause the processor to execute:
a resource identification module to identify a flight resource that is shared between a plurality of flight entities along with definitions and attributes that are associated with the flight resource;
an entity authorization module to determine which flight entities have been authorized to view and schedule the flight resource;
a shared calendar module that provides the shared schedule for a flight resource to the plurality of flight entities and manages a flight resource's schedule; and
a resource scheduling module to receive a request to use a shared flight resource during a block of time from a flight entity, and determine whether the flight entity is authorized to schedule the flight resource using the entity authorization module, and determine whether the flight resource is available for use during the block of time requested using the shared calendar module.

20. A system as in claim 18, further comprising a resource management module configured to enable an originating entity to manage a flight resource that the originating flight entity is sharing with another flight entity.

21. A system as in claim 19, wherein the resource management module is further configured to allow the originating flight entity to create and edit definitions and attributes for a shared flight resource.

22. A system as in claim 18, further comprising a user interface module configured to provide a flight entity with a user interface to the shared schedule for the flight resource and a user interface to manage the flight entity's flight resources.
